(19) United States
(12) Patent Application Publication
(10) Pub. No.: US 2006/0227128 A1
(43) Pub. Date: Oct. 12, 2006

(54) Imaging apparatus including an incising unit

(75) Inventor: Adam Jude Ahne, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International Inc.

(21) Appl. No.: 11/093,165

(22) Filed: Mar. 29, 2005

(51) Int. Cl. G06F 17/00

(52) U.S. Cl. 345/418

(57) ABSTRACT

An imaging apparatus includes a printing unit and an incising unit. A processor is communicatively coupled to the printing unit and the incising unit. The processor processes job data for use by at least one of the printing unit and the incising unit. An input device is located at the imaging apparatus. The input device is communicatively coupled to the processor. The input device has a first state to select an incising operation and having a second state wherein the incising operation is not selected. The processor executes program instructions to receive a status of the input device, and when the incising operation is selected via the input device, at least a portion of the job data is processed by the processor as incising data.

### BACKGROUND OF THE INVENTION

1. Field of the Invention

The present invention relates to an imaging apparatus, and more particularly, to an imaging apparatus that can perform incising functions in addition to printing.

2. Description of the Related Art

Various devices are available for performing perforation and/or cutting operations. Such devices may be standalone devices, requiring the purchase of additional hardware. Other such devices combine a perforation or cutting device with an imaging device. What is needed in the art is a user interface that permits a user to easily and intuitively operate the incising features of an imaging apparatus that includes an incising unit.

### SUMMARY OF THE INVENTION

The invention, in one form thereof, is directed to an imaging apparatus including a printing unit and an incising unit. A processor is communicatively coupled to the printing unit and the incising unit. The processor processes job data for use by at least one of the printing unit and the incising unit. An input device is located at the imaging apparatus. The input device is communicatively coupled to the processor. The input device has a first state to select an incising operation and has a second state wherein the incising operation is not selected. The processor executes program instructions to receive a status of the input device, and when the incising operation is selected via the input device, at least a portion of the job data is processed by the processor as incising data.

The invention, in another form thereof, is directed to an imaging system including a host and an imaging apparatus communicatively coupled to the host. The imaging apparatus includes a printing unit and an incising unit. A processor is associated with at least one of the host and the imaging apparatus. The processor is communicatively coupled to the printing unit and the incising unit. The processor processes job data for use by at least one of the printing unit and the incising unit. An input device is located at the imaging apparatus. The input device is communicatively coupled to the processor. The input device has a first state to select an incising operation and has a second state wherein the incising operation is not selected. The processor executes program instructions to receive a status of the input device, and when the incising operation is selected via the input device, at least a portion of the job data corresponding to a next job is processed by the processor as incising data.

The present invention, in another form thereof, is directed to a method for processing job data for an imaging apparatus having a printing unit and an incising unit. The method includes monitoring a status of an input device located at the imaging apparatus, the input device having a first state to select an incising operation and having a second state wherein the incising operation is not selected; and processing at least a portion of the job data corresponding to a next job as incising data when the incising operation is selected via the first input device.

An advantage of the present invention, for example, is that the user may select an incising operation for the next job to be processed while being present at the imaging apparatus.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of a system embodying the present invention.

FIG. 2 is a diagrammatic representation of the imaging apparatus included in the system of FIG. 1.

FIG. 3 is a general flowchart of a method for processing job data for an imaging apparatus having a printing unit and an incising unit, in accordance with the present invention.

Corresponding reference characters indicate corresponding parts throughout the several views. The exemplifications set out herein illustrate one or more embodiments of the invention, and such exemplifications are not to be construed as limiting the scope of the invention in any manner.

### DETAILED DESCRIPTION OF THE INVENTION

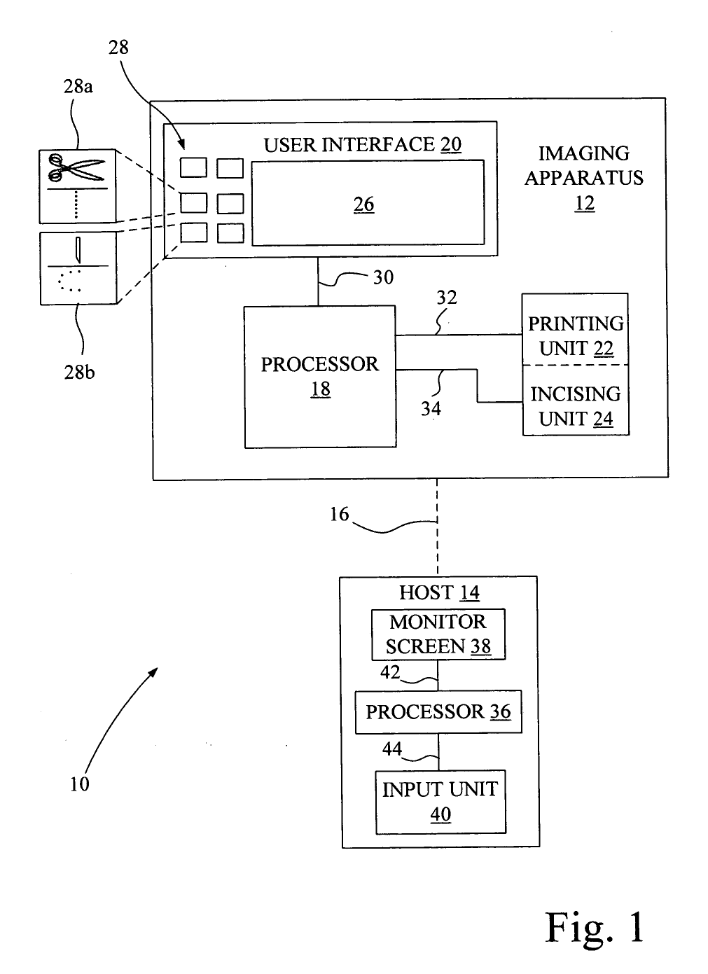

Referring now to the drawings and particularly to FIG. 1, there is shown a system 10 embodying the present invention. System 10 includes an imaging apparatus 12, and optionally, a host 14.

Imaging apparatus 12 may be, for example, a combined printer/incising apparatus, and may take the form of a multi-function device (MFD), such as for example, a standalone unit that has incising, scanning, copying, and/or faxing functionality, in addition to printing functionality. Host 14, which may be optional, may be communicatively coupled to imaging apparatus 12 via a communications link 16. Communications link 16 is depicted as a dashed line to represent the optional coupling of imaging apparatus 12 to host 14.

As used herein, the term “communications link” generally refers to structure that facilitates electronic communication between two components, and may operate using wired or wireless technology. Accordingly, communications link 16 may be, for example, a direct electrical wired connection, a direct wireless connection (e.g., infrared or r.f.), or a network connection (wired or wireless), such as for example, an Ethernet local area network (LAN) or a wireless networking standard, such as IEEE 802.11.

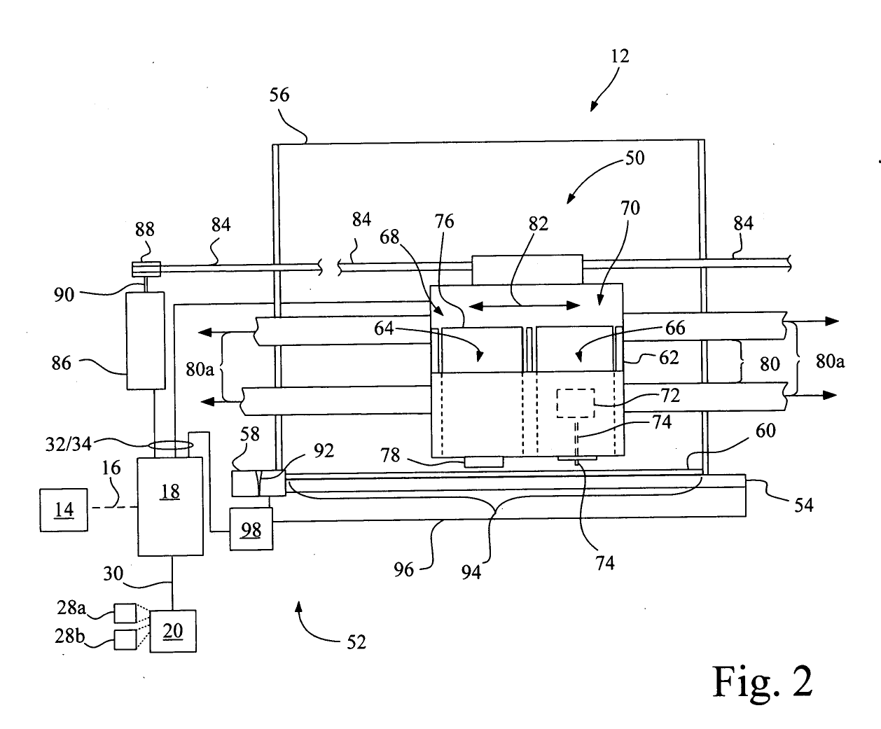

Imaging apparatus 12 includes a processor 18, a user interface 20, a printing unit 22 and an incising unit 24. With the present invention, it is advantageous in some embodiments for incising unit 24 to be combined with printing unit 22 in a single imaging apparatus, as shown in FIGS. 1 and 2. However, those skilled in the art will recognize that the principles of the present invention may be achieved in systems where incising unit 24 is independent from printing unit 22.

Processor 18 of imaging apparatus 12 may be, for example, an application specific integrated circuit (ASIC) having processing capabilities, and may include a microprocessor and associated memory. Processor 18 is communicatively coupled to user interface 20 via a communications link 30. Processor 18 is communicatively coupled to printing unit 22 via a communications link 32. Processor 18 is communicatively coupled to incising unit 24 via a communications link 34.

Processor 18 executes program instructions, in firmware or software, to provide operational control of printing unit 22 and an incising unit 24. In some embodiments of imaging apparatus 12, such as for example where imaging apparatus 12 is a multifunction device (MFD), processor 18 may include in its memory a software or firmware program including program instructions that function as a driver for printing unit 22 and/or incising unit 24, and will be referred to herein as a driver program. The driver program, for example, may include a halftoning unit and a data formatter subroutine that places print data and print commands in a format that can be recognized by printing unit 22, and may include an incising driver subroutine for identifying perforation/cutting boundaries, and for placing perforation and/or cutting instructions or data in a format that can be recognized by incising unit 24.

In addition, processor 18 executes program instructions to process job data for use by at least one of printing unit 22 and incising unit 24. The job data may be data generated locally, as when imaging apparatus 12 is operating in a standalone mode. For example, the driver program may be accessed by an application, such as for example, a label making application, a card stock application, etc., that is executing on imaging apparatus 12. Alternatively, the job data may be generated remotely, as when the job data is supplied by host 14 to imaging apparatus 12. The job data may include printing data and/or incising data, or job data including only printing data may be processed to generate incising data in accordance with one embodiment of the present invention.

User interface 20 includes a display screen 26 and a plurality of input devices 28. Display screen 26 may be, for example, a liquid crystal display (LCD). Display screen 26 may display, for example, a preview of the incising operation to be performed. The plurality of input devices 28 include, for example, an input device 28a and an input device 28b. Each of the plurality of input devices 28 are communicatively coupled to processor 18 via communications link 30.

In one embodiment, for example, each of input device 28a and input device 28b may include a selection indicator, which may be in the form of a backlit button, which when actuated, i.e., selected, is illuminated. For example, the user will press the button and its light, or associated LED, will turn on and stay on. If the button is pressed a second time the light will turn off. If desired, the lit button can slowly pulsate to remind the user that an incising operation is enabled. Input device 28a and input device 28b, which are physically located at imaging apparatus 12, may be formed, for example, as discrete buttons. Alternatively, input device 28a and/or input device 28b may be in the form of keys on a keyboard, or as touch buttons on an interactive display presented on display screen 26.

Processor 18 executes program instructions to receive a status of each of input device 28a and input device 28b.

Input device 28a, when in an ON state, is used to select a first type of incising operation to be performed by incising unit 24. In the case where input device 28a is a backlit button, for example, the button will be illuminated. When input device 28a is in an OFF state, then the first type of incising operation is not selected, and the backlit button will not be illuminated. For example, when the first type of incising operation is selected via said input device 28a, at least a portion of the job data corresponding to a next job is processed by processor 18 as incising data in accordance with the first type of incising. As a more specific example, if the job data of a next job is printing data and input device 28a has been actuated, then the driver program executing on processor 18 will identify boundary data for the printing data for use as incising coordinates during the incising operation that was selected by input device 28a at imaging apparatus 12.

Likewise, input device 28b, when in an ON state, is used to select a second type of incising operation to be performed by incising unit 24, which is different from the first type of incising operation. In the case where input device 28b is a backlit button, for example, the button will be illuminated. When input device 28b is in an OFF state, then the first type of incising operation is not selected, and the backlit button will not be illuminated. For example, when the second type of incising operation is selected via said input device 28b, at least a portion of the job data corresponding to a next job is processed by processor 18 as incising data in accordance with the second type of incising. As a more specific example, if the job data of a next job is printing data and input device 28b has been actuated, then the driver program executing on processor 18 will identify boundary data for the printing data for use as incising coordinates during the incising operation that was selected by input device 28b at imaging apparatus 12.

The first type of incising operation may be, for example, a cutting operation, and the second type of incising operation may be, for example, a perforating operation.

Also, where incising unit 24 uses a perforating device, such as a needle, the first incising operation may be performed at a first perforation density and the second incising operation performed at a second perforation density different from the first perforation density. For example, if the first incising operation is a cutting operation, then the perforation density may be, for example, around 150 perforations per inch, whereas the second incising operation may be effected at a lower perforation density, such as for example, around 75 perforations per inch, or some other desired perforation density, to bring about the desired result, albeit cutting or perforating.

As shown in the example of FIG. 1, each of input device 28a and input device 28b includes an icon which is used to indicate to a user the type of incising operation with will be selected when the respective input device is actuated. For example, the icon may be configured so as to convey to a user a perforation density of the incising operation. As a more specific example, input device 28a may include a scissors icon to indicate a cutting operation, and input device 28b may include a needle icon to represent a perforation operation at some predetermined perforation density.

Printing unit 22 may be, for example, an ink jet print engine, or other suitable print engine for forming an imaging on a substrate, such as a sheet of paper, or label stock. Incising unit 24 may include, for example, a perforation device and/or a cutting device. One example of a perforation device, which can also be used for cutting, includes a reciprocating needle assembly, and is described in further detail below with respect to FIG. 2. Known cutting devices include, for example, rotary cutters and knife cutters.

In embodiments including host 14, host 14 may be, for example, a personal computer including a processor 36, a monitor screen 38 and an input unit (e.g., keyboard) 40, and associated input/output (I/O) interfaces. Processor 36 may include, for example, a microprocessor and associated memory, such as RAM, ROM, NVRAM, and a mass data storage device, such as a hard drive, CD-ROM and/or DVD units.

Processor 36 is communicatively coupled to monitor screen 38 via communications link 42. Processor 36 is communicatively coupled to input unit 40 via communications link 44. Further, processor 36 is communicatively coupled to processor 18 of imaging apparatus 12 via communication link 16.

In embodiments that include host 14, host 14 may include in its memory all or a portion of the driver program including program instructions that function as a driver for imaging apparatus 12. The driver program, for example, may include a halftoning unit and a data formatter subroutine that places print data and print commands in a format that can be recognized by printing unit 22, and may include an incising driver subroutine for identifying perforation/cutting boundaries, and for placing perforation and/or cutting instructions or data in a format that can be recognized by incising unit 24. In addition, processor 18 executes program instructions to process job data for use by at least one of printing unit 22 and incising unit 24. The driver program may be accessed, for example, by a software application, such as for example, a word processing application, label making application, a card stock application, etc., that is executing on host 14.

In addition, processor 36 is communicatively coupled to input device 28a and input device 28b, both located at imaging apparatus 12, via processor 18 and communications links 16 and 30. Accordingly, processor 36 may also execute program instructions to receive a status of input device 28a and/or input device 28b.

For example, when the first type of incising operation is selected via input device 28a, at least a portion of the job data corresponding to a next job may be processed by processor 36 as incising data in accordance with the first type of incising. As a more specific example, if the job data of a next job is printing data and input device 28a has been actuated, then the driver program executing on processor 36 will identify boundary data for the printing data for use as incising coordinates during the incising operation that was selected by input device 28a at imaging apparatus 12.

Likewise, when the second type of incising operation is selected via input device 28b, at least a portion of the job data corresponding to a next job is processed by processor 36 as incising data in accordance with the second type of incising. As a more specific example, if the job data of a next job is printing data and input device 28b has been actuated, then the driver program executing on processor 36 will identifying boundary data for the printing data for use as incising coordinates during the incising operation that was selected by input device 28b at imaging apparatus 12.

A preview of the selected incising operation may be displayed on display screen 26 of imaging apparatus 12 and/or monitor screen 38 of host 14.

FIG. 2 is one exemplary embodiment of imaging apparatus 12, including printing unit 22 and incising unit 24, which may be used in conjunction with the present invention.

Printing unit 22 and incising unit 24 collectively include, for example, a carrier system 50, a feed roller unit 52, a mid-frame 54, a media source 56, and an incising maintenance station 58.

Media source 56 is configured and arranged to supply from a stack of media a sheet of media 60 to feed roller unit 52, which in turn further transports the sheet of media 60 during a printing operation and/or a perforation operation.

Carrier system 50 includes a carrier 62, i.e., carriage, that is configured with one or more bays, for example bay 64 and bay 66. Each of bays 64, 66 is mechanically and electrically configured to mount, carry and facilitate one or more types of printhead cartridges 68, such as a monochrome printhead cartridge and/or a color printhead cartridge, and/or a perforator cartridge 70 that includes a perforation mechanism 72 driving a perforation device 74, such as a needle or blade, in a reciprocating manner.

Each printhead cartridge 68 includes an ink reservoir 76 provided in fluid communication with a printhead 78, which may include multiple ink jet nozzle arrays. Multiple printheads may be included on printhead cartridge 68. Perforator cartridge 70 is sized and configured to be mechanically and electrically compatible with the configuration of the printhead cartridges 68 so as to be interchangeable therewith in carrier 62 in one of bays 64 and 66.

Carrier 62 is guided by a pair of guide members 80. Either, or both, of guide members 80 may be, for example, a guide rod, or a guide tab formed integral with the imaging apparatus frame. The axes 80a of guide members 80 define a bi-directional scanning path 82 of carrier 62. Carrier 62 is connected to a carrier transport belt 84 that is driven by a carrier motor 86 via a carrier pulley 88. In this manner, carrier motor 86 is drivably coupled to carrier 62 via carrier transport belt 84, although one skilled in the art will recognize that other drive coupling arrangements could be substituted for the example given, such as for example, a worm gear drive. Carrier motor 86 can be, for example, a direct current motor or a stepper motor. Carrier motor 86 has a rotating motor shaft 90 that is attached to carrier pulley 88. Carrier motor 86 is coupled, e.g., electrically connected, to processor 18 via communications link 32.

Incising maintenance station 58 includes an abrasive member 92, such as a ceramic material, arranged to receive and sharpen a perforation device 74, such as for example, a needle or a blade.

At a directive of processor 18, carrier 62 is transported in a controlled manner along bi-directional scanning path 82, via the rotation of carrier pulley 88 imparted by carrier motor 86. During printing, processor 18 controls the movement of carrier 62 so as to cause carrier 62 to move in a controlled reciprocating manner, back and forth along guide members 80. In order to conduct perforator maintenance operations, e.g., sharpening, processor 18 controls the movement of carrier 62 to position carrier 62 in relation to incising maintenance station 58. Printhead 78 is electrically connected to processor 18 via communications link 32. Perforation mechanism 72 is electrically connected to processor 18 via communications link 34.

During a printing/incising operation, wherein the incising operation may be selected by one of input device 28a and input device 28b, the reciprocation of carrier 62 transports printhead 78 and perforation mechanism 72 across the sheet of media 60 along bidirectional scanning path 82, i.e., a scanning direction, to define a print/incising zone 94 of imaging apparatus 12. Bi-directional scanning path 82 is parallel with axes 80a of guide members 80, and is also commonly known as the horizontal direction. Processor 18 supplies electrical address and control signals to the ink jetting actuators of printhead 78 to effect the selective ejection of ink from printhead 78. Further processor 18 supplies control signals to perforation mechanism 72 to effect the selective actuation of perforation mechanism 72 for performing perforating or cutting operations using perforation device 74. During each scan of carrier 62, the sheet of media 60 is held stationary by feed roller unit 52. Feed roller unit 52 includes a feed roller 96 and a drive unit 98. The sheet of media 60 is transported through print/incising zone 94 by the rotation of feed roller 96 of feed roller unit 52. A rotation of feed roller 96 is effected by drive unit 98. Drive unit 98 is electrically connected to processor 18 via communications link 32.

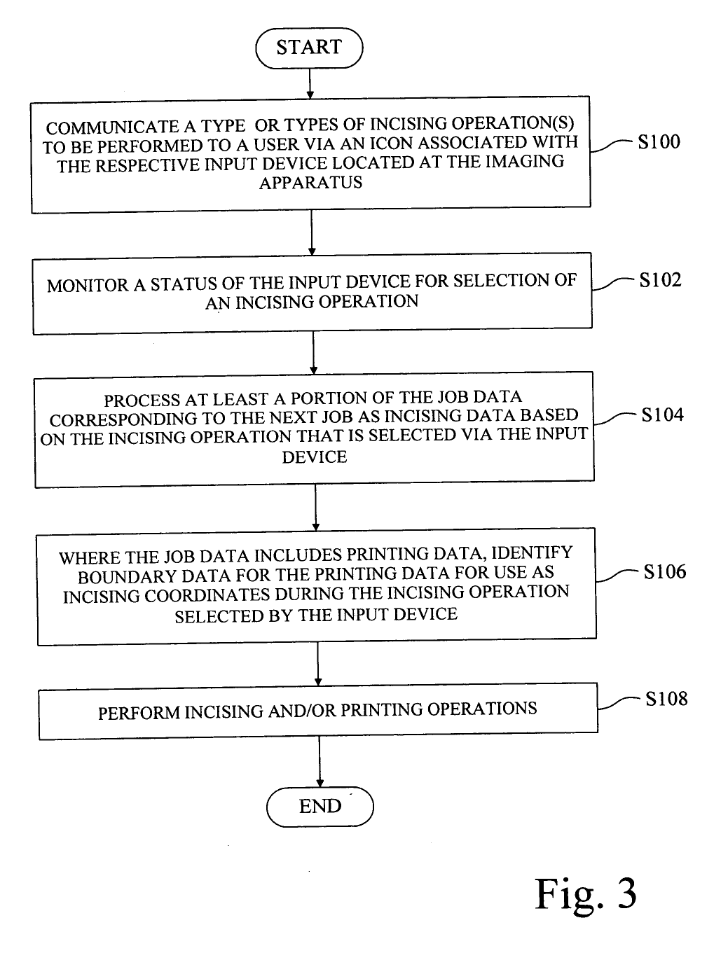

FIG. 3 is a general flowchart of a method for processing job data for an imaging apparatus, such as imaging apparatus 12, having a printing unit such as printing unit 22 and an incising unit such as incising unit 24.

At step S100, a type or types of incising operation(s) that may be performed is communicated to a user via an icon associated with the respective input device located at the imaging apparatus. In the examples given above with respect to FIG. 1, input device 28a includes a scissors icon representing a cutting operation. In addition, input device 28b includes a needle icon representing a perforation operation at a predetermined perforation density.

At step S102, a status of the input device, such as input device 28a and/or input device 28b, located at imaging apparatus 12 is monitored, e.g., read, by processor 18. Input device 28a and input device 28b represent two different types of incising operations, as more fully described above, which may be respectively selected for use with the next job, depending upon which of input device 28a and input device 28b is actuated. The status check of input device 28a and/or input device 28b may occur, for example, at the start of each job.

If the driver program which drives printing unit 22 and incising unit 24 resides in imaging apparatus 12, then processor 18 of imaging apparatus 12 will retain the determined status for further use in processing the job. Alternatively, if for example the driver program resides in host 14, then processor 18 of imaging apparatus 12 will supply the status for reception by processor 36 of host 14 for further use in processing the job.

At step S104, the processor designated for use in an incising operation, i.e., processor 18 and/or processor 36, processes via the driver program at least a portion of the job data corresponding to the next job as incising data based on the incising operation that is selected via input device 28a or input device 28b. If no incising operation is selected by input device 28a or input device 28b, however, then the driver program will process the job as a print job, without any incising operation.

At step S106, when one of input device 28a and input device 28b was selected and the job data includes printing data, boundary data is identified for the printing data for use as incising coordinates during the selected incising operation. Since the present invention is not dependent on a particular type of boundary determination algorithm, the boundary identification for use in the incising operation may be performed, for example, using any of a variety of different boundary determination algorithms, such as those known in the art.

Optionally, the driver program may begin a job that involves incising by displaying a pop-up window with perforation options on display sccreen 26 of imaging apparatus 12, including a preview window showing the automatically detected boundary, e.g., edges, of the graphic objects in the job being processed. In this case, a single input device, such as one of input device 28a and input device 28b, may be used to accommodate a plurality of incising operations, e.g., accommodate a plurality of perforation densities.

At step S108, the incising and/or printing operations are performed based, at least in part, on the job data and the status of input device 28a and/or input device 28b.

While this invention has been described with respect to exemplary embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An imaging apparatus, comprising:
a printing unit;
an incising unit;
a processor communicatively coupled to said printing unit and said incising unit, said processor processing job data for use by at least one of said printing unit and said incising unit; and
a first input device located at said imaging apparatus, said first input device communicatively coupled to said processor, said first input device having a first state to select an incising operation and having a second state wherein said incising operation is not selected;
said processor executing program instructions to receive a status of said first input device, and when said incising operation is selected via said first input device, at least a portion of said job data is processed by said processor as incising data.

2. The imaging apparatus of claim 1, wherein said first input device is a first button having an icon representing said incising operation to be performed.

3. The imaging apparatus of claim 2, wherein said icon is indicative of a perforation density of said incising operation.

4. The imaging apparatus of claim 1, said first input device including an indicator to indicate that said incising operation has been selected.

5. The imaging apparatus of claim 1, further comprising a second input device communicatively coupled to said processor, wherein when actuated said first input device selects a first type of incising operation and, when actuated said second input device selects a second type of incising operation different from said first incising operation.

6. The imaging apparatus of claim 5, wherein said first type of incising operation is performed at a first perforation density and said second type of incising operation is performed at a second perforation density different from said first perforation density.

7. The imaging apparatus of claim 1, wherein said job data includes printing data.

8. The imaging apparatus of claim 1, wherein said processor executes a driver program functioning as a printing/incising driver for said printing unit and said incising unit.

9. The imaging apparatus of claim 8, wherein said job data includes printing data, said driver program identifying boundary data for said printing data for use as incising coordinates during said incising operation.

10. The imaging apparatus of claim 9, further comprising a display, wherein a preview of said incising operation is displayed on said display.

11. An imaging system, comprising:
a host;
an imaging apparatus communicatively coupled to said host, said imaging apparatus including a printing unit and an incising unit;
a processor is associated with at least one of said host and said imaging apparatus, said processor being communicatively coupled to said printing unit and said incising unit, said processor processing job data for use by at least one of said printing unit and said incising unit; and
a first input device located at said imaging apparatus, said first input device communicatively coupled to said processor, said first input device having a first state to select an incising operation and having a second state wherein said incising operation is not selected;
said processor executing program instructions to receive a status of said first input device, and when said incising operation is selected via said first input device, at least a portion of said job data corresponding to a next job is processed by said processor as incising data.

12. The imaging system of claim 11, wherein said first input device is a first button having an icon representing said incising operation to be performed.

13. The imaging system of claim 12, wherein said icon is indicative of a perforation density of said incising operation.

14. The imaging system of claim 11, said first input device including an indicator to indicate that said incising operation has been selected.

15. The imaging system of claim 11, further comprising a second input device communicatively coupled to said processor, wherein when actuated said first input device selects a first type of incising operation and, when actuated said second input device selects a second type of incising operation different from said first incising operation.

16. The imaging system of claim 15, wherein said first type of incising operation is performed at a first perforation density and said second type of incising operation is performed at a second perforation density different from said first perforation density.

17. The imaging system of claim 11, wherein said job data includes printing data.

18. The imaging system of claim 11, wherein said processor executes a driver program functioning as a printing/incising driver for said printing unit and said incising unit.

19. The imaging system of claim 18, wherein said job data includes printing data, said driver program identifying boundary data for said printing data for use as incising coordinates during said incising operation.

20. The imaging system of claim 19, further comprising a display, wherein a preview of said incising operation is displayed on said display.

21. A method for processing job data for an imaging apparatus having a printing unit and an incising unit, comprising:
monitoring a status of an input device located at said imaging apparatus, said input device having a first state to select an incising operation and having a second state wherein said incising operation is not selected; and
processing at least a portion of said job data corresponding to a next job as incising data when said incising operation is selected via said first input device.

22. The method of claim 21, wherein said job data includes printing data, said method comprising identifying boundary data for said printing data for use as incising coordinates during said incising operation.

23. The method of claim 21, comprising communicating said status to a driver program executing on at least one of said imaging apparatus and a host.

24. The method of claim 21, comprising communicating a type of incising operation to be performed to a user via an icon associated with said input device.

25. The method of claim 24, wherein said icon is indicative of a perforation density of said incising operation.

26. The method of claim 21, wherein said input device has associated therewith plurality of perforation options.
